(19) United States
(12) Patent Application Publication
(10) Pub. No.: US 2017/0199936 A1
(43) Pub. Date: Jul. 13, 2017

(54) METHODS AND SYSTEMS FOR SEARCH ENGINES SELECTION & OPTIMIZATION

(71) Applicant: Veritone, Inc., Newport Beach, CA (US)

(72) Inventors: Chad Steelberg, Newport Beach, CA (US); Nima Jalali, Newport Beach, CA (US); James Bailey, Newport Beach, CA (US); Blythe Reyes, Newport Beach, CA (US); James Williams, Newport Beach, CA (US); Eileen Kim, Newport Beach, CA (US); Ryan Stinson, Newport Beach, CA (US)

(21) Appl. No.: 15/405,172

(22) Filed: Jan. 12, 2017

Related U.S. Application Data
(60) Provisional application No. 62/277,944, filed on Jan. 12, 2016.

(51) Int. Cl. G06F 17/30

(52) U.S. Cl. CPC G06F 17/30864; G06F 17/30867

(57) ABSTRACT

A method for conducting a cognitive search is provided. The method comprises: receiving, at a server, a search profile comprising embedded data characteristics, sending a search request, using a processor, to a database of search engines, selecting a defined subset of search engines from the database based on the search profile, requesting the defined subset of search engines to conduct a real-time searching based on the search profile, requesting real-time searching progress data from the defined subset of search engines, collecting real-time searching progress data from the defined subset of search engines, and choose at least one optimally-selected search engine based on the real-time searching progress data from the defined subset of search engines.

### CROSS-REFERENCE TO RELATED APPLICATION

This application claims priority to U.S. Provisional Application No. 62/277,944 entitled “METHODS, SYSTEMS AND DEVICES FOR COGNITIVE DATA RECOGNITION AND MEDIA PROFILES”, filed Jan. 12, 2016, which application is hereby incorporated in its entirety by reference. This application is related to a co-pending U.S. Non-Provisional application Ser. No. 15/405,091, entitled “USER INTERFACE FOR MULTIVARIATE SEARCHING,” filed Jan. 12, 2017, which is assigned to the same ASSIGNEE and is hereby incorporated in its entirety by reference.

### BACKGROUND

Since the advent of the Internet, our society is in an ever-increasing connected world. This connected world has led to a massive amount of multimedia being generated every day. For example, with improved smartphone technology, that allows individuals to personally record live events with ease and simplicity, video and music are constantly being generated. There is also ephemeral media, such as radio broadcasts. Once these media are created, there is no existing technology that indexes all of the content and allows it to be synchronized to an exact time slice within the media, for instance when events happen. Another example is an individual with thousands of personal videos stored on a hard drive, who wishes to find relevant ones with the individual's grandmother and father who may wish to create a montage. Yet another example is an individual who wishes to find the exact times in a popular movie series when a character says “I missed you so much.” Yet another example is an individual who wishes to programmatically audit all recorded phone calls from an organization in order to find a person who is leaking corporate secrets.

These examples underscore how specific content within audio and video media is inherently difficult to access, given the limitations of current technology. There have been solutions that provide limited information around the media, such as a file name or title, timestamps, lengths of media file recordings, and others but none currently analyze and index the data contained within the media.

A conventional solution is to use dedicated search engines such as Bing, Google, Yahoo!, or IBM Watson. These dedicated search engines are built to perform searches based on a string input, which can work very well for simple searches. However, for more complex multivariable searches, conventional search engines are not accurate and do not work most of the time.

### SUMMARY

Provided herein are embodiments of devices, methods, and systems for improved searching and analysis of the data content within media files and creation of profiles associated therewith using cognitive data recognition. Such devices, methods, and systems include the ability to process media files via search engines to understand and recognize the data content contained within a media file, correlate the media file and its data content with other media files and data content stored in search engines or other databases, generate an output, and if required, predict outcomes. For example, such devices, methods, and systems allow an individual to determine and recognize that at a time 1:57 of a video file playing at a normal speed what particular words were spoken, the sentiment or other inflection of those words, and identification of particular music playing or faces show in the video at that time.

Also provided herein are embodiments of devices, methods, and systems that provide users or individuals the ability to create cognitive profiles. As such, this provides users the ability to predefine and save individual multifaceted search parameters across cognitive engine types. These cognitive profiles can be independent objects that can be used to run real time searches, create watchlists (such as programmatic and automated searches), and filtering based on saved search parameter criteria. Cognitive profiles can be added together, stacked, or otherwise combined to provide even more comprehensive search capabilities. Cognitive profiles can thus provide a “one click” or other simple functionality to generate, filter, or generate and filter multi-faceted search results.

In an embodiment, a method for conducting a cognitive search is provided. The method comprises: receiving, at a server or a computing device, a search profile comprising embedded data characteristics, selecting a defined subset of search engines from the database based on the search profile, requesting the defined subset of search engines to conduct a real-time searching based on the search profile, requesting real-time searching progress data from the defined subset of search engines, collecting real-time searching progress data from the defined subset of search engines, and choose at least one optimally-selected search engine based on the real-time searching progress data from the defined subset of search engines.

In an embodiment, a non-transitory processor-readable medium is provided. The non-transitory processor-readable medium has one or more instructions operational on a computing device, which when executed by a processor causes the processor to: command a real-time searching of a search profile with embedded data characteristics from a defined database of search engines, analyze a real-time searching progress data from the defined database of search engines, choose at least one optimally-selected search engine based on the real-time searching progress data from the defined database of search engines, and generate a real-time result using at least one optimally-selected search engine.

Other systems, devices, methods, features, and advantages of the subject matter described herein will be or will become apparent to one with skill in the art upon examination of the following figures and detailed description. It is intended that all such additional devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 illustrates an exemplary environment in accordance to embodiments of the disclosure.

FIG. 2 illustrates an exemplary user interface in accordance to embodiments of the disclosure.

FIG. 3 illustrates an exemplary process for search engine selection and optimization in accordance to embodiments of the disclosure.

FIG. 4 illustrates an exemplary process for searching using chain cognition in accordance to embodiments of the disclosure.

FIGS. 5-6 illustrate exemplary processes for selecting a primary search engine in accordance to embodiments of the disclosure.

FIG. 7 illustrates an exemplary process for search engine selection based on training data in accordance to embodiments of the disclosure.

FIG. 8 is a block diagram of an exemplary multivariate search system in accordance with some embodiments of the disclosure.

FIG. 9 is a block diagram illustrating an example of a hardware implementation for an apparatus employing a processing system that may exploit the systems and methods of FIGS. 3-8 in accordance with some embodiments of the disclosure.

### DETAILED DESCRIPTION

### Overview

As described above, although there exists technology for creating and recording of various media files, there is no existing technology that facilitates easy analysis and searching of content stored within the media files. Specifically, there is no existing technology that indexes all of the content, synchronizes it to an exact time slice within the media, for instance when events happen, and analyzes those slices. There have been solutions that provide limited information around the media, such as a file name or title, timestamps, lengths of media file recordings, and others but none currently index, synchronize, and analyze the data content contained within the media. Furthermore, there is no technology currently that goes a step beyond mere analysis of the data content within media files. Specifically, there is no technology that takes a user query; searches in the recorded and stored media files; indexes, synchronizes, and analyzes the data content within the media files; and after analyzing the data content within media files extrapolates to generate a predictive result based on the user's query.

Provided herein are embodiments of devices, methods, and systems for improved searching. In some embodiments, devices, methods, and systems include the ability to process media files via search engines to understand and recognize the data content contained within a media file, correlate the media file and its data content with other media files and data content stored in search engines or other databases, generate an output, and if required, predict outcomes.

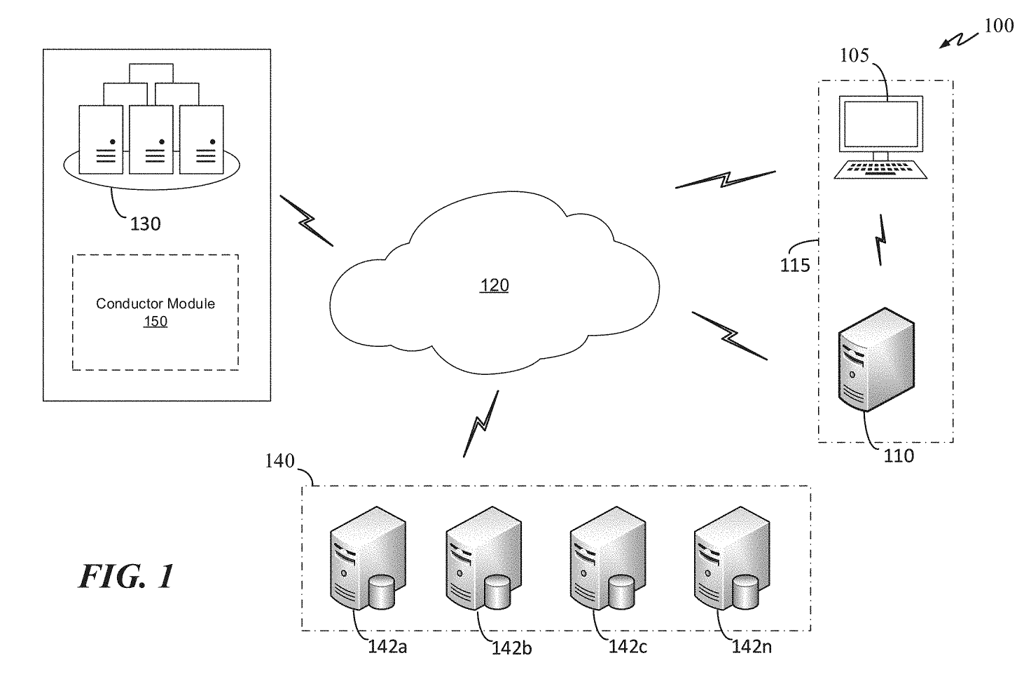

FIG. 1 illustrates an environment 100 in which the systems and methods for multivariate searching and the search engine selection & optimization process can operate in accordance with some embodiments of the disclosure. Environment 100 may include a client device 105 and a server 110. Both of client device 105 and server 110 may be on the same local area network (LAN) or wide area network (WAN). In some embodiments, client device 105 and server 110 are located at a point of sale (POS) 115 such as a store, a supermarket, a stadium, a movie theatre, or a restaurant, etc. Alternatively, POS 115 may reside in a home, a business, or a corporate office. Client device 105 and server 110 are both communicatively coupled to network 110, which may be the Internet.

Environment 100 may also include remote server 130 and a plurality of search engines 142a through 142n. Remote server 130 may maintain a database of search engines that may include a collection 140 of search engines 142a-n. Remote server 130 itself may be a collection of servers and may include one or more search engines similar to one or more search engines in collection 140. Search engines 142a-n may include a plurality of search engines such as but not limited to transcription engines, facial recognition engines, object recognition engines, voice recognition engines, sentiment analysis engines, audio recognition engines, etc.

In some embodiments, the search engine selection and optimization process is performed by a conductor module 150, which may reside at server 130. In some embodiments, conductor module 150 may reside on client side 115—as part of server 110 or on client device 105, for example. Conductor module 150 may also be distributedly located. In some embodiments, a main conductor may reside on server 130 and a plurality of sub-conductors may reside at various client sites such as POS 115. In some embodiments, sub-conductors are responsible for searches on local databases or historical dataset while the main conductor may coordinate searches on search engines across the world (including search engines and databases at various POS sites). To best describe how conductor module 150 works, it is best to first revisit the prior art/conventional approach to searching. When conducting a search on a conventional search engine such as Google, the user may direct the search engine to perform a search using only the alphanumeric text string such as “images of Snoopy playing tennis.” Here, the words “images of” are not part of the subject to be searched but rather they are instruction words for the engine. This assumes the engine is smart enough to figure out which words are instruction words and which words are subject(s) to be searched. In the above example, the input string is simple and most search engines would not have an issue parsing the out the instruction words and words to be searched (search-subject words). However, the input strings can get complicated when several search subjects and type of searches are involved. For example, given the input string “videos or images of John McCain talking about charitable giving with a positive sentiment,” it is much harder for a traditional search engine to accurately and quickly parse out instruction words and search-subject words. When performing the above search using traditional search engines, the results are most likely irrelevant. Additionally, traditional search engines would not be able to inform the user with a high level of confidence whether such a video exists.

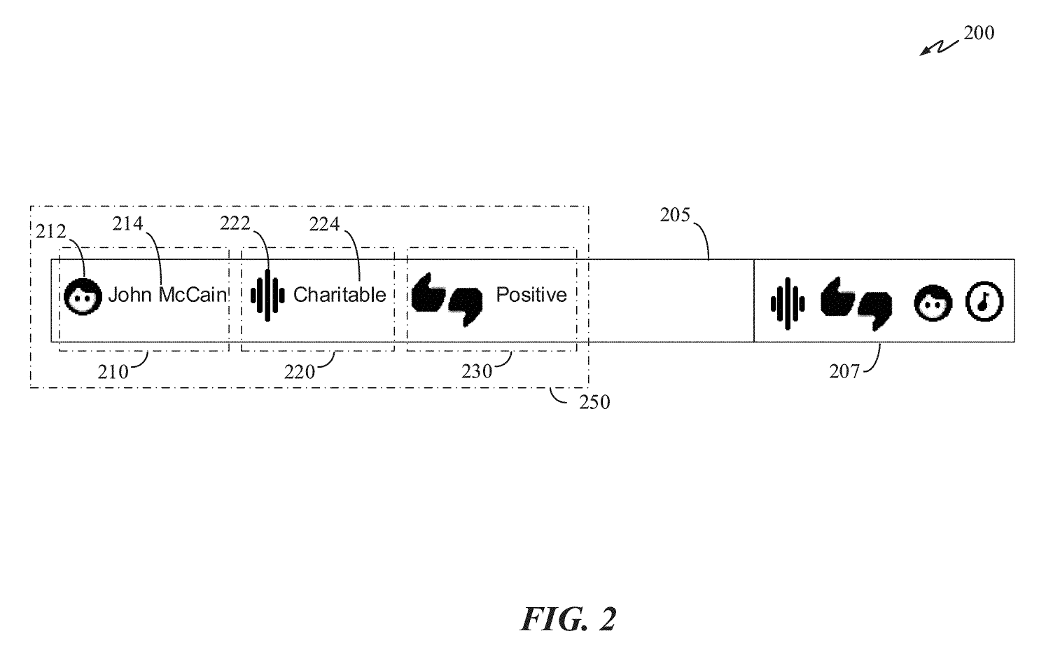

However, this type of search would not be a big issue for the multivariate search system as disclosed herein. On a high level, the multivariate search system—which include the search engine selection & optimization process—is configured to receive a search input having the above search terms, but in an entirely different format. FIG. 2 illustrates a multivariate search user interface 200 displaying a plurality search parameter groups 210, 220, and 230. Each of the search parameter groups may include an input portion (205) and a search type portion (207). The three search parameter groups 210, 220, and 230 make up a search profile 250, which may include any number of search parameter groups. As shown in FIG. 2, search parameter group 210 includes search type icon 212 and input portion 214 having the keywords “John McCain”. Essentially, search parameter group 210 tells the search conductor (conductor module 150) two main things. First, the topic to be search is “John McCain.” Secondly, the type of search is a facial recognition search as indicated by face icon 212. A facial recognition search is essentially a search for images and/or videos as no other medium contains information necessary for a facial recognition search. By knowing the type of search to be performed, conductor 150 may select a subset of search engines that are specifically designed for facial recognition. In this way, the relevancy and accuracy of the search result is vastly improved over prior art searching techniques. Further, rather than using a single search engine such as Watson, Google, or Bing, conductor 150 uses all existing search engines and leverages each of the search engine's strength and uniqueness and select one or more search engines to perform the search as specified by search profile 250.

Similarly, group 220 includes waveform icon 222 and text input 224 with the keyword “Charitable”. Upon receiving search profile 250, conductor knows that a transcription search is to be performed for the word charitable. Lastly, group 230 shows a thumbs icon associated with the word positive. This means the conductor will perform a search for a media with a positive sentiment. On a high level, conductor 250 breaks up search profile 250 into three separate searches. In some embodiments, all three searches may be performed asynchronously. Alternatively, the searches may be performed in succession—upon completion of a search for one of the three search parameter groups 210, 220, and 230, another search may begin. In some embodiments, the result from the previously completed search (or partial result) may be used as input in each of the successive search (also referred to as a chain cognition search). In this way, as the search progresses, the search dataset becomes narrower. For example, the first search may be for all images and videos of John McCain. The second search may be completely focused on the images and videos in the first result. Accordingly, rather than searching the entire human collection of videos for a clip where the word “Charitable” is in the transcription, the second search may focus only on the videos from the first result. This greatly reduces computation and searching time. Consequently, the search engine selection process of conductor 150 yields a much more accurate and faster search than current prior art techniques.

As mentioned, the conductor is configured to perform a multivariate (multi-dimensional) search using multiple search engines. The ability to perform a multivariate search over multiple search engines is incredibly advantageous over prior art single engine search technique because it allows the user to perform complex searches that is not currently possible with search engine like Google, Bing, etc. For example, using the disclosed multivariate search user interface, the user may perform a search for all videos of President Obama during the last 5 years standing in front of the Whitehouse Rose Garden talking about Chancellor Angela Merkel. This type of search is not possible with current prior art searching method or it is very slow and very hard to achieve.

Referring back again to FIG. 1, in some embodiments, server 110 may include one or more specialized search engines similar to one or more of search engines 142a-142n. In this way, a specialized search may be conducted at POS 115 using server 110 that may be specially designed to serve POS 115. For example, POS 115 may be a retailer like Macy's and server 110 may contain specialized search engines for facial and object recognition in order to track customers purchasing habits and to track and store shopping patterns. Server 110 may also work with one or more search engines in collection 140. Ultimately, the multivariate search system will be able to help Macy's management to answer questions such as “how many times did Customer A purchase ties or shoes during the last 6 months.” In some embodiments, client device 105 may communicate with server 130 to perform the same search. However, a localized solution may be more desirable for certain customers where a lot of data are locally generated such as a retail or grocery store that wishes to track purchasing habits/patterns or to make predictive analysis on sales and/or traffic patterns.

### Search Engine Selection and Optimization

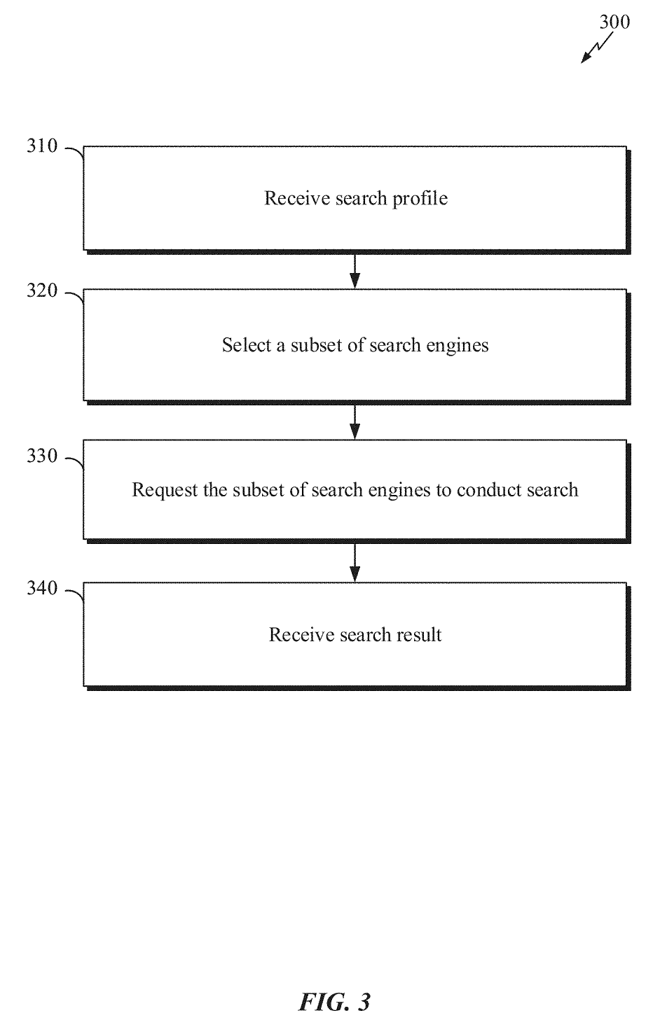

FIG. 3 is a flow chart illustrating a process 300 of conductor 150 performing a search on a search profile received from a multivariate UI in accordance with some embodiments of the disclosure. Process 300 starts at 310 where a search profile (e.g., search profile 250) is received from a multivariate UI (e.g., UI 200). At 320, a subset of search engines, from a database of search engines, is selected based on a search parameter of search profile 250. In some embodiments, the subset of search engines may be selected based on a portion of search parameter group 210, which may include an input string (e.g., 214) and a search type indicator (e.g., 212). In some embodiments, the subset of search engines is selected based on the search type indicator of search parameter group 210. For example, the search type indicator may be face icon 212, which represents a facial recognition search. In this example, process 300 (at 310) selects a subset of search engines that can perform facial recognition on an image, a video, or any type of media where a facial recognition may be performed. Accordingly, from a database of search engines, process 300 (at 310) may select one or more of a facial recognition engines such as PicTriev, Google Image, facesearch, TinEye, etc. As a further example, PicTriev and TinEye may be selected as the subset of search engines at 310. This eliminates the rest of the unselected facial recognition engines along with numerous of other search engines that may specialize in other types of searches such as voice recognition, object recognition, transcription, sentiment analysis, etc.

In some embodiments, process 300 is part of search conductor module 150 that is configured to select one or more search engines to perform a search based on search parameter groups 210, 220, and 230 (collectively search profile 250). As previously mentioned, each parameter group may include a search string and a search type indicator. In some embodiments, process 300 maintains a database of search engines and classifies each search engine into one or more categories to indicate the specialty of the search engine. The categories of search engine may include, but not limited to, transcription, facial recognition, object/item recognition, voice recognition, audio recognition (other than voice, e.g., music), etc. Rather than using a single search engine, process 300 leverages many search engines in the database by taking advantage of each search engine's uniqueness and specialty. For example, certain transcription engine works better with audio data having a certain bit rate or compression format. While another transcription engine works better with audio data in stereo with left and right channel information. Each of the search engine's uniqueness and specialty are stored in a historical database, which can be queried to match with the current search parameter to determine which database(s) would be best to conduct the current search.

In some embodiments, at 320, prior to selecting a subset of search engines, process 300 may compare one or more data attributes of the search parameter with attributes of databases in the historical database. For example, the search/input string of the search parameter may be a medical related question. Thus, one of the data attributes for the search parameter is medical. Process 300 then searches the historical database to determine which database is best suited for a medical related search. Using historical data and attributes preassigned to existing databases, process 300 may match the medical attribute of the search parameter with one or more databases that have previously been flagged or assigned to the medical field. Process 300 may use the historical database in combination with search type information of the search parameter to select the subset of search engines. In other words, process 300 may first narrows down the candidate databases using the search type information and then uses the historical database to further narrows the list of candidate databases. Stated differently, process 300 may first select a first group of database that can perform image recognition based the search type being a face icon (which indicate a facial recognition search), for example. Then using the data attributes of the search string, process 300 can select one or more search engines that are known (based on historical performance) to be good at searching for medical images.

In some embodiments, if a match or best match is not found in the historical database, process 300 may match the data attribute of the search parameter to a training data set, which is a set of data with known attributes used to test against a plurality of search engines. Once a search engine is found to work best with the training data set, then the search engine is associated with that training data set. In some embodiments, numerous number of training data sets are available. Each training data set has a unique set of data attributes such as one or more of attributes relating to medical, entertainment, legal, comedy, science, mathematics, literature, history, music, advertisement, movies, agriculture, business, etc. After running each training data set against multiple search engines, each training data set is matched with one or more search engines that have been found to work best for its attributes. In some embodiments, at 320, process 300 examines the data attributes of the search parameter and matches the attributes with one of the training data sets data attributes. Next, a subset of search engines is selected based on which search engines were previously associated to the training data sets that match with data attributes of the search parameter.

In some embodiments, data attributes of the search parameter and the training data set may include but not limited to type of field, technology area, year created, audio quality, video quality, location, demographic, psychographic, genre, etc. For example, given the search input “find all videos of Obama talking about green energy in the last 5 years at the Whitehouse,” the data attributes may include: politics; years created 2012-2017, location: Washington DC and White House.

At 330, the selected subset of search engines is requested to conduct a search using the search string portion of search parameter group 210, for example. In some embodiments, the selected subset of search engines includes only 1 search engine. At 340, the search result is received, which may be displayed.

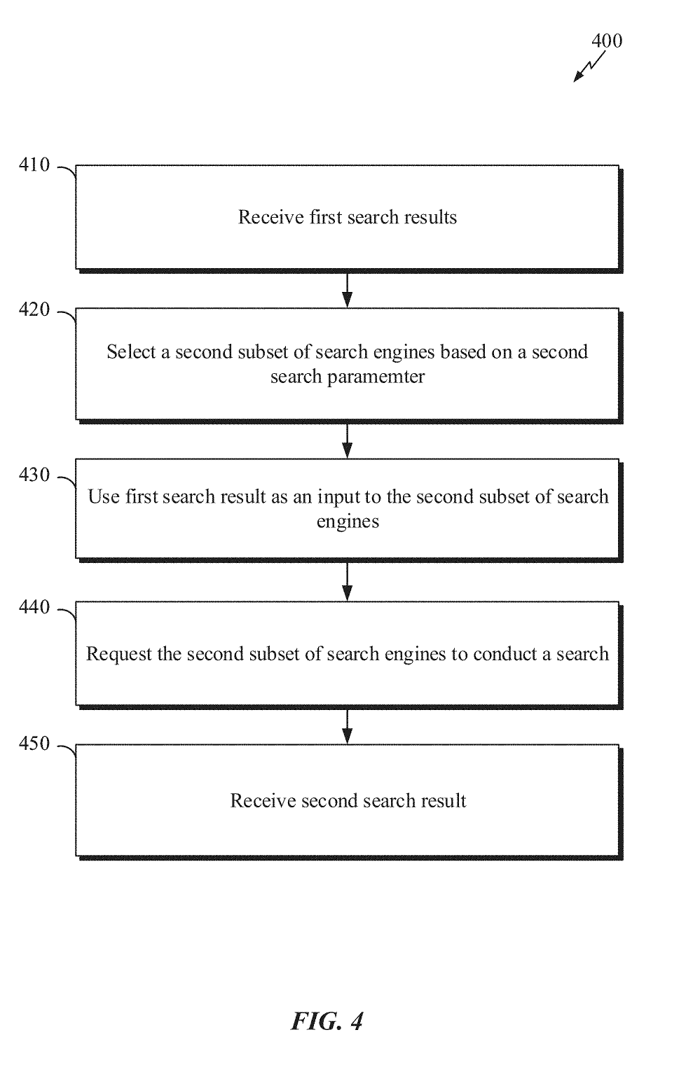

FIG. 4 is a flow chart illustrating a process 400 of conductor 150 for chain cognition, which is the process of chaining one search after another in accordance to some embodiments of the disclosure. Chain cognition is a concept not used by prior art search engines. On a high level, chain cognition is multivariate (multi-dimensional) search done on a search profile having two or more search parameters. For example, given the search profile: [symbol] _{President Obama} [symbol] _{John McCain} [symbol] _{Debt ceiling}, this search profile consists of three search parameter groups: face icon “President Obama”; voice recognition icon “John McCain”; and transcription icon “Debt ceiling.” This search profile requires at a minimum of 2 searches being chained together. In some embodiments, a first search is conducted for all multimedia with John McCain's voice talking about the debt ceiling. Once that search is completed, the results are received and stored (at 410). At 420, a second subset of search engines is selected based on the second search parameter. In this case, it may be a face icon, which means that the second search will only use facial recognition engines. Accordingly, at 420, only facial recognition engines are selected as the second subset of search engines. At 430, the results received at 410 are used as input for the second subset of search engines to help narrow and focus the search. At 440, the second subset of search engine is requested to find videos with President Obama present while John McCain is talking about the debt ceiling. Using the results at 410, the second subset of search engines will be able to quickly focus the search and ignore all other data not in the results from the first search. In the above example, it should be noted that the search order in the chain may be reversed by performing a search for all videos of President Obama first, then feeding that results into one or more voice recognition engines to look for John McCain voice and the debt ceiling transcription.

Additionally, in the above example, only 2 chain searches were conducted. However, in practice, many searches can be chained together to form a long (e.g., over 5 multivariate search chain) search chain.

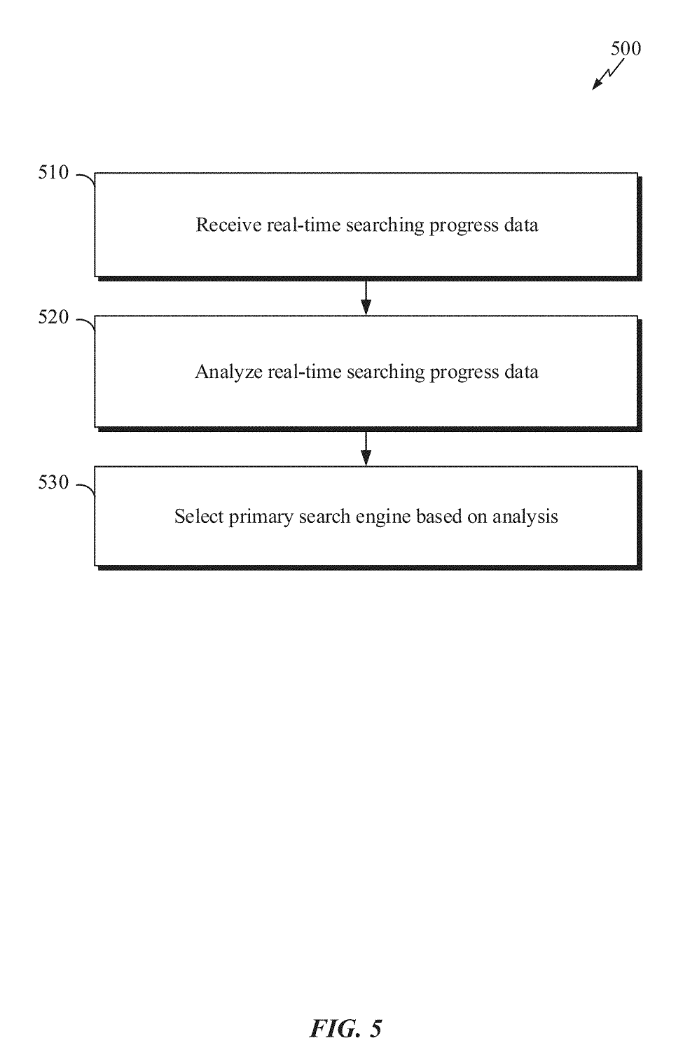

FIG. 5 illustrates a flow chart of process 500 of conductor 150 for analyzing real-time searching progress data to select a primary search engine in accordance with some embodiments of the disclosure. As previously mentioned, conductor 150 may select a subset of search engines based on one or more of the search type selection and attributes of the input string. In some embodiments, conductor 150 may select one or more search engines as the subset. In a situation where 2 or more search engines are in the selected subset, conductor 150 may eventually select one search engine as the primary search engine to save resources and costs associated with running a potentially 3^{rd} party search engine. In some embodiments, conductor 150 may select a second search engine to serve as a backup or secondary search engine.

At 510, real-time searching progress data is received by conductor 150, which may reside at a central server or at a POS. Real-time searching progress data may be actively requested by conductor 150. For example, conductor 150 may request each search engine in the selected subset of search engines to continuously or periodically send real-time searching progress data as the search progresses. Alternatively, searching progress data may be passively received without any active request. In some embodiments, real-time searching progress data may include, but not limited to, a confidence rating, a searching progress indicator (i.e., 25% completed), a third-party verified indicator, a human-verified indicator, a quality indicator, a trending indicator, and a total viewing indicator.

In some embodiments, conductor 150 may request transcription engines for a confidence rating associated with the result or partial result. For example, given a media and a transcription of the media, a transcription engine usually indexes the media, its transcription, and an accuracy score of the transcription. This accuracy score translates into a confidence rating which is associated to the media by the transcription engine. In some embodiments, the confidence rating may also be determined in real-time by comparing results from the transcription engine with another database or search engine. For example, the transcription of a certain famous clip may be verified by another provider or by a human reviewer (which may have previously verified the clip and the transcription). Accordingly, a third party-verified and/or human-verified indicator may be used concurrently with the confidence rating.

In some embodiments, the searching progress data of facial and voice recognition engines may be a third-party verified indicator, a human-verified indicator, a quality indicator, a trending indicator, and a total viewing indicator. Unlike transcription where the accuracy of transcribed words may be automatically verified and scored, confidence score for facial and voice recognition engines is largely binary. Accordingly, facial and voice recognition engines may provide one or more trust indicators to indicate whether the results have been verified by a third-party source (may be another automatic engine) or by a human reviewer.

At 520, real-time searching progress data received from each engine in the selected subset of search engines are analyzed and compared with progress data received from other search engines. For example, the received progress data for search engine A may include a confidence rating of 60% and a third-party verified indicator. For search engine B, the received progress data may include a confidence rating of 60%, a third-party verified indicator, a human-verified indicator, and a trending score of 90/100. Overall, conductor 150 may find that the total trust score for search engine B is higher than search engine A. Accordingly, at 530, conductor 150 selects search engine B to be the primary search engine to conclude the search or to conduct further search based on a given search profile. In some embodiments, conductor 150 may allow both search engines A and B to complete the search, but only results from search engine B will be used. In some embodiments, conductor 150 may select search engine A to server as a backup/secondary search engine.

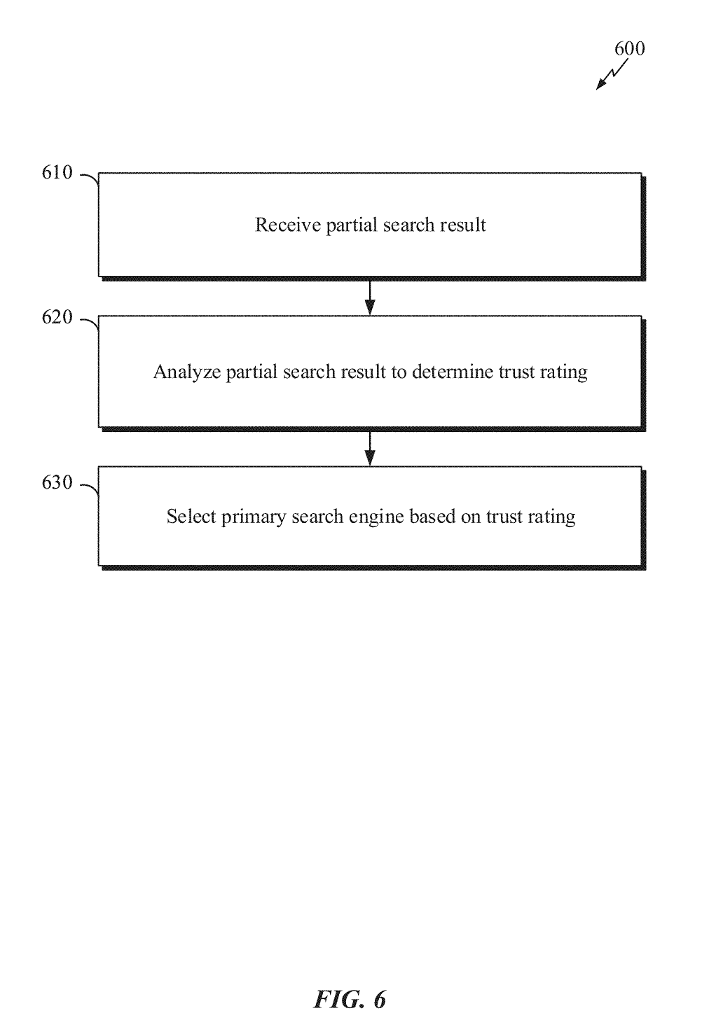

FIG. 6 illustrates a flow chart of process 600 of conductor 150 for analyzing partial search results to select a primary search engine in accordance with some embodiments of the disclosure. As previously stated, conductor 150 may select a subset of search engines based attributes of the input string and/or the search type selection (e.g., face icon, transcription icon, etc.). To save costs, conductor 150 may select one of the search engine from the selected subset of search engines to operate as the primary search engine. In some embodiments, engines not selected to serve as the primary search engine are requested to terminate all pending search processes.

Process 600 starts at 610 where a partial search result and its associated metadata are received. At 620, the partial search result and its metadata are analyzed and assigned a trust rating or score. Similar to the real-time search progress data, the trust score may include one or more of a confidence rating, a searching progress indicator (i.e., 25% completed), a third-party verified indicator, a human-verified indicator, a quality indicator, a trending indicator, and a total viewing indicator. Upon analyzing the partial results and metadata from search engines A and B, search engine A may receive a total trust score of 80 out of 100 because the partial results could be verified with a third-party and the quality for the image/video is high. Whereas, the trust score for search engine B may be determined to be 50 out of 100 because the partial results could not be verified with a third party or by a human. In addition, the quality of the image/video identified by search engine B could be bad. Accordingly, at 630, the primary search engine is selected based on the engine with the highest trust score.

### Training Data Set and Historical Data

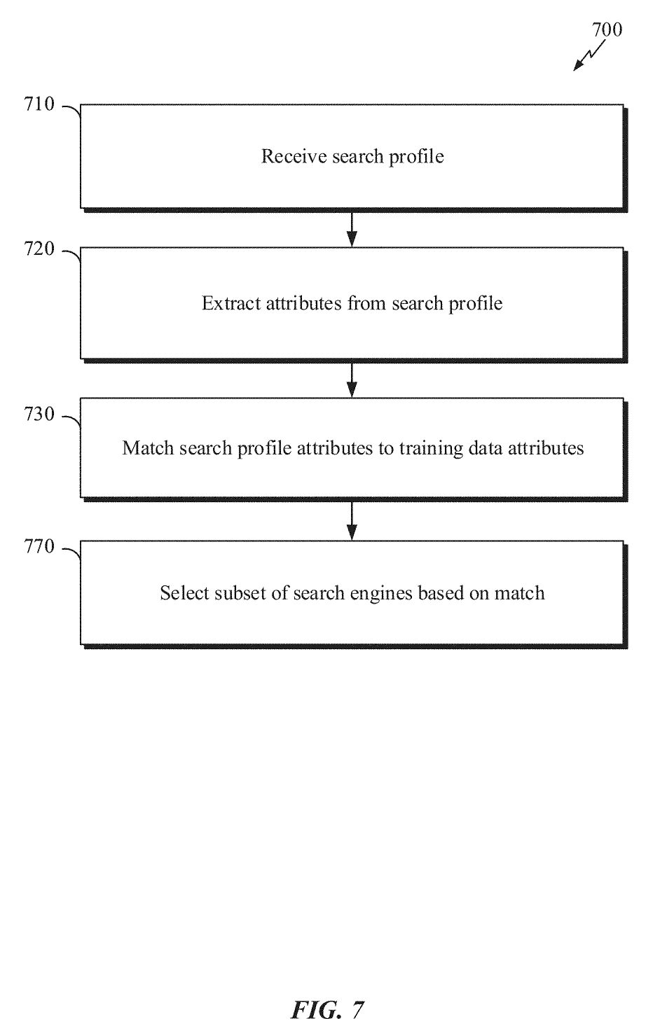

FIG. 7 is a flow chart illustrating a process 700 for selecting a subset of search engines based on attributes of the search profile and training data in accordance to some embodiments of the disclosure. As previously mentioned, the multivariate search system disclosed herein includes conductor 150, which is mainly responsible for the selection & optimization of one or more search engines to perform a search. In some embodiments, process 700 of conductor 150 is configured to receive a search profile (at 710) having one or more search parameters (typically at least 2). For example, FIG. 2 shows search profile 250 that includes search parameters 210, 220, and 230. Each of the search parameter groups may include an input string portion (e.g., 214, 224) and a search type portion (e.g., 212, 222). A lot of useful information may be extracted from each parameter group. For example, in examining search parameter group 210, conductor 150 can determine that the topic to be search is “John McCain,” and that the type of search is a facial recognition search (as indicated by face icon 212). By knowing the type of search to be performed, conductor 150 may select a subset of search engines that are specifically designed for facial recognition. In this way, the relevancy and accuracy of the search result is vastly improved over prior art searching technique, which is to use a single search engine such as Watson, Google, or Bing to perform a search regardless of the search complexity and type of data involved. Whereas, conductor 150 uses all existing search engines (e.g., transcription engines, facial recognition engines, voice recognition engines, object recognition engines, etc.) and leverages each of the search engine's strength and uniqueness and select one or more search engines to perform the search as specified by search profile 250. In some embodiments, the use of training data set and historical data are some of the ways to leverage a search engine's strength and uniqueness.

After receiving the search profile at 710, process 700 of conductor 150 selects a subset of search engines to perform the search as specified by the received search profile. In some embodiments, conductor 150 may select the subset of search engines based on one more of the search type portion (e.g., 212, 222), training data, and historical data. To select the subset of search engines based on training data, process 700 may extract one or more attributes from the search profile (at 720). In some embodiments, one or more attributes are extracted from the input string portion (e.g., 214, 224). For example, given the input string “what was Justice Ginsburg's stand on abortion in 1985?”, the attributes for this input string may be “legal”, “supreme court justices”, “abortion”, “law.” At 730, conductor 150 finds one or more training data sets with similar attributes. For example, a legal training data set may have the following attributes: legal, law, and politics. Accordingly, at 730, conductor 150 matches the above input string with the legal training data set. At 770, a subset of search engines that have been previously determined to work best with the legal training data set is selected.

For each training data set, conductor 150 runs the training data set (using a hypothetical search) against multiple search engines to determine which search engines work best for the type of data in the training set. Conductor 150 then associates the training data set with one or more search engines that have been found to perform the best. This process may be repeated periodically to update the database.

Conductor 150 may also use historical data in similar ways to select a subset of search engines. For example, the input string of a search parameter may be an engineering related question. Thus, one of the data attributes for the search parameter is engineering. Conductor 150 then searches the historical database to determine which database is best suited for an engineering related search. Using historical data and attributes that have been preassigned to existing databases, conductor 150 may match the engineering attribute of the search parameter with one or more databases that have previously been flagged or assigned to the engineering field. It should be noted that conductor 150 may use the historical database in combination with a training data set and the search type information of the search parameter to select the subset of search engines. In some embodiments, data attributes for a search parameter, a training data set, and a historical database may include, but not limited to, field, area of technology, year created, audio quality, video quality, location, demographic, psychographic, genre, etc.

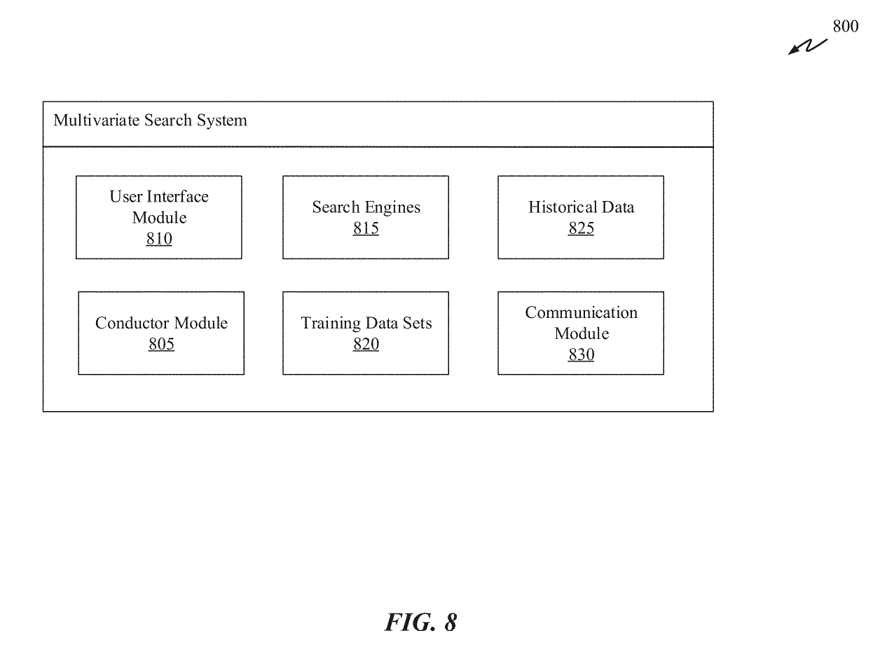

FIG. 8 illustrates a system diagram of a multivariate search system 800 in accordance with embodiments of the disclosure. System 800 may include a search conductor module 805, user interface module 810, a collection of search engines 815, training data sets 820, historical databases 825, and communication module 830. System 1000 may reside on a single server or may be distributedly located. For example, one or more components (e.g., 805, 810, 815, etc.) of system 1000 may be distributedly located at various locations on a network. User interface module 810 may reside either on the client side or the server side. Similarly, conductor module 805 may also reside either on the client side or server side. Each component or module of system 800 may communicate with each other and with external entities via communication module 830. Each component or module of system 800 may include its own sub-communication module to further facilitate with intra and/or inter-system communication.

User interface module 810 may contain codes and instructions which when executed by a processor will cause the processor to generate user interface 200 (as shown in FIG. 2). Conductor module 805 may be configured to perform processes 300, 400, 500, 600, and 700 as described in FIGS. 3 through 7. In some embodiments, search conductor module 805 main task is to select the best search engine from the collection of search engines 815 to perform the search based on one or more of: the inputted search parameter, historical data (stored on historical database 825), and training data set 820.

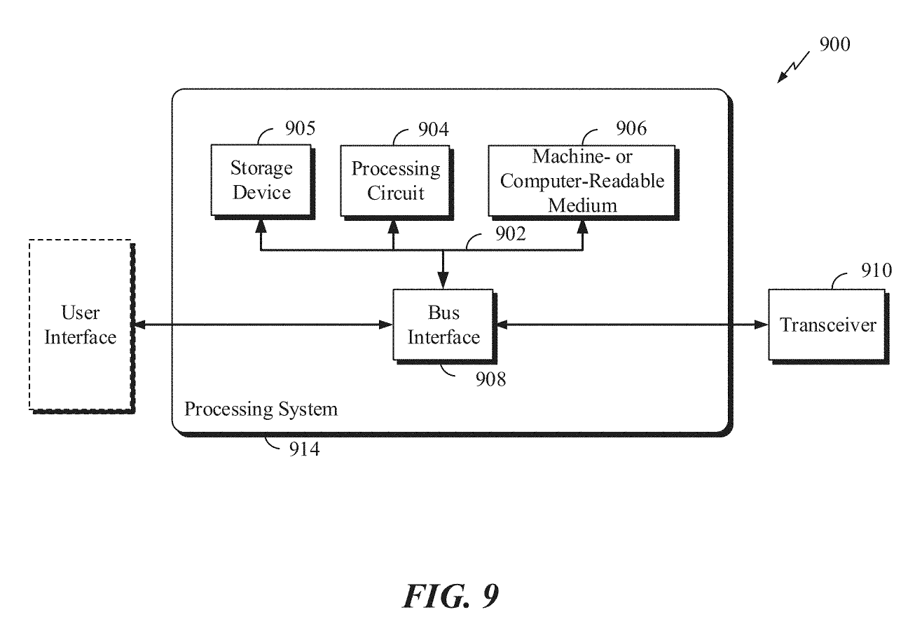

FIG. 9 illustrates an overall system or apparatus 900 in which processes 300, 400, 500, 600, and 700 may be implemented. In accordance with various aspects of the disclosure, an element, or any portion of an element, or any combination of elements may be implemented with a processing system 914 that includes one or more processing circuits 904. Processing circuits 904 may include micro-processing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionality described throughout this disclosure. That is, the processing circuit 904 may be used to implement any one or more of the processes described above and illustrated in FIGS. 3 through 7.

In the example of FIG. 9, the processing system 914 may be implemented with a bus architecture, represented generally by the bus 902. The bus 902 may include any number of interconnecting buses and bridges depending on the specific application of the processing system 914 and the overall design constraints. The bus 902 links various circuits including one or more processing circuits (represented generally by the processing circuit 904), the storage device 905, and a machine-readable, processor-readable, processing circuit-readable or computer-readable media (represented generally by a non-transitory machine-readable medium 908.) The bus 902 may also link various other circuits such as timing sources, peripherals, voltage regulators, and power management circuits, which are well known in the art, and therefore, will not be described any further. The bus interface 908 provides an interface between bus 902 and a transceiver 910. The transceiver 910 provides a means for communicating with various other apparatus over a transmission medium. Depending upon the nature of the apparatus, a user interface 912 (e.g., keypad, display, speaker, microphone, touchscreen, motion sensor) may also be provided.

The processing circuit 904 is responsible for managing the bus 902 and for general processing, including the execution of software stored on the machine-readable medium 908. The software, when executed by processing circuit 904, causes processing system 914 to perform the various functions described herein for any particular apparatus. Machine-readable medium 908 may also be used for storing data that is manipulated by processing circuit 904 when executing software.

One or more processing circuits 904 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The software may reside on machine-readable medium 908. The machine-readable medium 908 may be a non-transitory machine-readable medium. A non-transitory processing circuit-readable, machine-readable or computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer. The terms “machine-readable medium”, “computer-readable medium”, “processing circuit-readable medium” and/or “processor-readable medium” may include, but are not limited to, non-transitory media such as portable or fixed storage devices, optical storage devices, and various other media capable of storing, containing or carrying instruction(s) and/or data. Thus, the various methods described herein may be fully or partially implemented by instructions and/or data that may be stored in a “machine-readable medium,” “computer-readable medium,” “processing circuit-readable medium” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer.

The machine-readable medium 908 may reside in the processing system 914, external to the processing system 914, or distributed across multiple entities including the processing system 914. The machine-readable medium 908 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Note that the aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

1. A method for conducting a search, the method comprising:
receiving, at a computing device, a search profile having one or more search parameters, wherein the computing device contains a database of search engines;
selecting a subset of search engines from the database of search engines based on the one or more search parameters;
requesting the selected subset of search engines to conduct a search based on the one or more search parameters; and
receiving a search result from the selected subset of search engines.

2. The method of claim 1, wherein requesting the selected subset of search engines further comprises:
receiving real-time searching progress data from the selected subset of search engines in response to the request; and
selecting at least one search engine, from the selected subset of search engines, as a primary search engine based on the real-time searching progress data.

3. The method of claim 2, wherein real-time search progress data include one or more selected from the group consisting of a confidence rating, a searching progress indicator, a third-party verified indicator, a human-verified indicator, a quality indicator, a trending indicator, and a total viewing indicator.

4. The method of claim 1, wherein requesting the selected subset of search engines further comprises:
receiving a partial search result from the selected subset of search engines;
determining a trust rating for each of the selected subset of search engines based on the received partial results; and
selecting at least one search engine, from the selected subset of search engines, as a primary search engine based on the determined trust rating, wherein the trust rating is based on one or more of a confidence rating, a searching progress indicator, a third-party verified indicator, a human-verified indicator, a quality indicator, a trending indicator, and a total viewing indicator.

5. The method of claim 4, wherein the partial search result comprises substantially all of the result.

6. The method of claim 1, wherein each of the one or more search parameters comprises a search string and a search type indicator, wherein the subset of search engines is selected based on the search type indicator.

7. The method of claim 6, wherein the search type indicator includes one or more selected from the group consisting of a transcription search, a facial recognition search, a voice recognition search, an audio search, an object search, a sentiment search, and a keyword search.

8. The method of claim 1, further comprises:
matching attributes of the search profile with attributes of a training data set based on similarity between the attributes of the training data set and attributes of the one or more search parameters of the search profile; and
selecting the subset of search engines based on the matched training data.

9. The method of claim 1, wherein the selected subset of search engines comprises at least one search engine.

10. The method of claim 9, further comprises running at least one primary search engine and at least one secondary search engine simultaneously.

11. The method of claim 1, wherein the database of search engines comprises one or more transcription engines, facial recognition engines, object recognition engines, voice recognition engines, sentiment analysis engines, and keywords search engines.

12. The method of claim 1, further comprises sending a search termination request to search engines not selected as either the primary search engine or secondary processing engine.

13. A non-transitory processor-readable medium having one or more instructions operational on a computing device, which when executed by a processor causes the processor to:
receive, at a computing device, a search profile having one or more search parameters, wherein the computing device contains a database of search engines;
select a subset of search engines from the database of search engines based on the one or more search parameters;
request the selected subset of search engines to conduct a search based on the one or more search parameters; and
receive a search result from the selected subset of search engines.

14. The non-transitory processor-readable medium of claim 13, further comprises instructions which when executed by a processor causes the processor to:
receive real-time searching progress data from the selected subset of search engines in response to the request; and
select at least one search engine, from the selected subset of search engines, as a primary search engine based on the real-time searching progress data.

15. The non-transitory processor-readable medium of claim 14, wherein real-time search progress data include one or more selected from the group consisting of a confidence rating, a searching progress indicator, a third-party verified indicator, a human-verified indicator, a quality indicator, a trending indicator, and a total viewing indicator.

16. The non-transitory processor-readable medium of claim 13, further comprises instructions which when executed by a processor causes the processor to:
receive a partial search result from the selected subset of search engines;
determine a trust rating for each of the selected subset of search engines based on the received partial results; and
select at least one search engine, from the selected subset of search engines, as a primary search engine based on the determined trust rating, wherein the trust rating is based on one or more of a confidence rating, a searching progress indicator, a third-party verified indicator, a human-verified indicator, a quality indicator, a trending indicator, and a total viewing indicator.

17. (canceled)

18. The non-transitory processor-readable medium of claim 13, wherein each of the one or more search parameters comprises a search string and a search type indicator, wherein the subset of search engines is selected based on the search type indicator.

19. The non-transitory processor-readable medium of claim 18, wherein the search type indicator includes one or more selected from the group consisting of a transcription search, a facial recognition search, a voice recognition search, an audio search, an object search, a sentiment search, and a keyword search.

20. The non-transitory processor-readable medium of claim 13, further comprises instructions which when executed by a processor causes the processor to:
match attributes of the search profile with attributes of a training data set based on similarity between the attributes of the training data set and attributes of the one or more search parameters of the search profile; and
select the subset of search engines based on the matched training data.

21. (canceled)

22. The non-transitory processor-readable medium of claim 13, wherein the database of search engines comprises one or more transcription engines, facial recognition engines, object recognition engines, voice recognition engines, sentiment analysis engines, and keywords search engines.

23. (canceled)
